(19) United States
(12) Patent Application Publication
(10) Pub. No.: US 2021/0149502 A1
(43) Pub. Date: May 20, 2021

(54) MOUSE PERIPHERAL DEVICE AND MOUSE CABLE HOLDER THEREOF

(71) Applicant: Primax Electronics Ltd., Taipei (TW)

(72) Inventor: Shih-Ying Hsiao, Taipei (TW)

(21) Appl. No.: 16/730,268

(22) Filed: Dec. 30, 2019

(30) Foreign Application Priority Data
Nov. 15, 2019 (TW) 108141628

(51) Int. Cl. G06F 3/039; G06F 3/0354

(52) U.S. Cl. CPC G06F 3/0395; G06F 3/03543

(57) ABSTRACT

A mouse peripheral device includes a mouse pad module and a mouse cable holder. The mouse cable holder includes a base and a cable clamp element. The base is installed on the mouse pad module. The cable clamp element is installed on the base. The mouse peripheral device can be assembled and disassembled by the user. Consequently, the volume of the product package is reduced, and the mouse peripheral device is easily carried by the user.

### FIELD OF THE INVENTION

The present invention relates to a peripheral device of a computer, and more particularly to a mouse peripheral device and a mouse cable holder of the mouse peripheral device.

### BACKGROUND OF THE INVENTION

The widely-used computer peripheral input devices include for example mouse devices, keyboard devices or trackballs. As known, mouse devices are prevailing because they are very easy-to-use. When a mouse device is held by a user's palm, the user may move the mouse device to control the movement of the cursor shown on the computer screen. In addition, by manipulating the buttons of the mouse device with the user's fingers, the user may click and select a desired icon shown on the computer screen or execute a corresponding function. As a consequence, most users and most manufacturers of the input devices pay much attention to the keyboard devices.

Generally, a main body of the mouse device to be held by the user is placed on a desk surface, and a cable of the mouse hangs under the desk surface naturally. The operation of the mouse device has the following drawbacks. Firstly, if the hanging direction of the mouse cable is different from the moving direction of the main body, the weight of the mouse cable may influence the moving capability of the main body. Secondly, the end of the mouse cable close to the main body is readily rubbed against the desk surface or the mouse pad, and thus a friction drag force is generated. Thirdly, even if the surplus portions of the mouse cable are held together by a cable tie, the weight of the mouse cable may also influence the moving capability of the main body. Because of the above drawbacks, the mouse device cannot be operated smoothly.

Recently, a mouse cable holder has been introduced into the market. By the mouse cable holder, the end of the mouse cable of the mouse device that is close to the main body is ascended and fixed. Consequently, the moving capability of the main body is not adversely affected by the mouse cable. For example, a conventional mouse cable holder is disclosed in Chinese Patent Publication No. CN105988606. For enhancing the functionality of the product, a mouse peripheral device integrating a mouse cable holder and a mouse pad has also been introduced into the market. However, since the overall volume of the mouse peripheral device is bulky, the mouse peripheral device is not easily carried by the user.

In other words, the conventional mouse peripheral device and the conventional mouse holder need to be further improved.

### SUMMARY OF THE INVENTION

An object of present invention provides a mouse peripheral device. The mouse peripheral device can be assembled and disassembled by the user. Consequently, the volume of the product package is reduced, and the mouse peripheral device is easily carried by the user.

An object of present invention provides a mouse cable holder for the mouse peripheral device.

In accordance with an aspect of the present invention, a mouse peripheral device is provided. The mouse peripheral device includes a mouse pad module and a mouse cable holder. The mouse pad module includes a mouse pad and a fixing frame. A mouse device is movable on the mouse pad. The mouse pad is accommodated within an accommodation space of the fixing frame. The fixing frame includes a frame coupling part. The mouse cable holder includes a base and a cable clamp element. The base includes a first base coupling part. Through the first base coupling part and the frame coupling part, the base is permitted to be assembled with the fixing frame or disassembled from the fixing frame by a user. The cable clamp element includes a first end part and a second end part. The first end part and the second end part are respectively located at two opposite ends of the cable clamp element. The first end part is coupled with the base. The second end part is inclined and extended upwardly. The second end part comprises a clamping part, and a mouse cable is clamped by the clamping part.

In accordance with another aspect of the present invention, a mouse cable holder is provided. The mouse cable holder includes a base and a cable clamp element. The base is disposed on a placement surface, and includes a first base coupling part. The cable clamp element includes a first end part and a second end part. The first end part and the second end part are respectively located at two opposite ends of the cable clamp element. The first end part includes a clamp coupling part. The second end part is inclined and extended upwardly. The second end part includes a clamping part. A mouse cable is clamped by the clamping part. Through the clamp coupling part and the first base coupling part, the cable clamp element is permitted to be assembled with the base or disassembled from the base by a user.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the appearance of a mouse peripheral device according to an embodiment of the present invention;

FIG. 2 is a schematic side view illustrating the mouse peripheral device as shown in FIG. 1;

FIG. 3 schematically illustrating the use of the mouse peripheral device as shown in FIG. 1 to clamp a mouse cable;

FIG. 4 schematically illustrates the mouse peripheral device as shown in FIG. 1 in a disassembled status;

FIG. 5 schematically illustrates the mouse pad module and the cable clamp element of the mouse peripheral device as shown in FIG. 4 and taken along another viewpoint;

FIG. 6 is a schematic side view illustrating a process of assembling the mouse pad assembly with the base or disassembling the mouse pad assembly from the base; and

FIG. 7 is a schematic side view illustrating a process of assembling the base with the cable clamp element or disassembling the base from the cable clamp element.

### DETAILED DESCRIPTION OF THE PREFERRED EMBODIMENT

The embodiments of present invention will be described more specifically with reference to the following drawings. Generally, in the drawings and specifications, identical or similar components are designated by identical numeral references. For well understanding the present invention, the elements shown in the drawings are not in scale with the elements of the practical product. In the following embodiments and drawings, the elements irrelevant to the concepts of the present invention or the elements well known to those skilled in the art are omitted. It is noted that numerous modifications and alterations may be made while retaining the teachings of the invention.

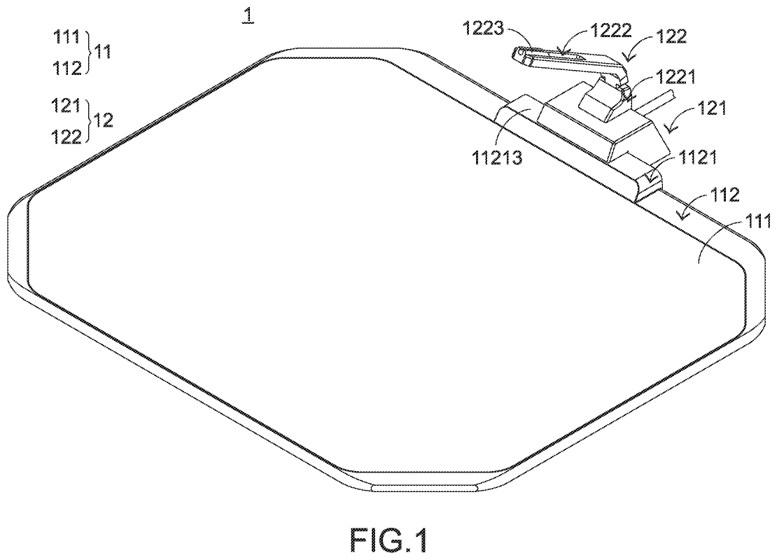

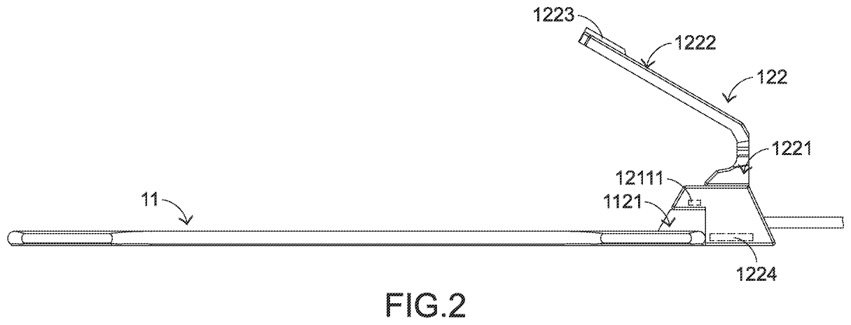

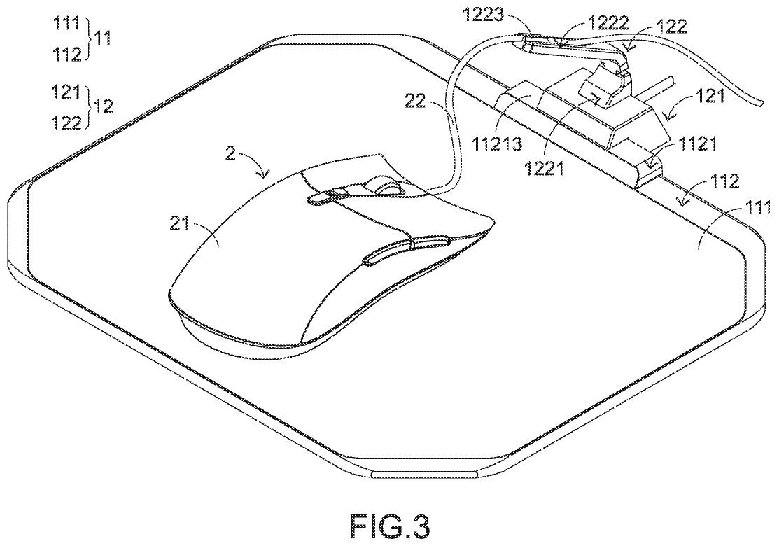

Please refer to FIGS. 1, 2 and 3. FIG. 1 is a schematic perspective view illustrating the appearance of a mouse peripheral device according to an embodiment of the present invention. FIG. 2 is a schematic side view illustrating the mouse peripheral device as shown in FIG. 1. FIG. 3 schematically illustrating the use of the mouse peripheral device as shown in FIG. 1 to clamp a mouse cable. The mouse peripheral device 1 comprises a mouse pad module 11 and a mouse cable holder 12. The mouse pad module 11 comprises a mouse pad 111 and a fixing frame 112. The mouse pad 111 is accommodated within an accommodation space of the fixing frame 112. While the mouse device 2 is operated by the user, the user may hold a main body 21 of the mouse device 2 and move the main body 21 on the mouse pad 111.

The mouse cable holder 12 comprises a base 121 and a cable clamp element 122. The base 121 is disposed on an edge of the fixing frame 112. The cable clamp element 122 comprises a first end part 1221 and a second end part 1222. The first end part 1221 and the second end part 1222 are located at two opposite ends of the cable clamp element 122. The first end part 1221 is coupled with the base 121. The second end part 1222 is inclined and extended upwardly. The second end part 1222 comprises a clamping part 1223. In the usage state of the mouse device 2, a mouse cable 22 is clamped by the clamping part 1223. Consequently, the end of the mouse cable 22 close to the main body 21 is ascended. In such way, the moving capability of the main body 21 is not influenced by the mouse cable 22.

Preferably but not exclusively, the cable clamp element 122 is made of rubbery material. Consequently, the cable clamp element 122 can be slightly swung along the moving direction of the main body 21 of the mouse device 2. In other words, the main body 21 can be moved more smoothly. Optionally, a weight block 1224 is disposed within the base 121 to increase the weight of the base 121. Consequently, the possibility of causing collapse of the base 121 is largely reduced.

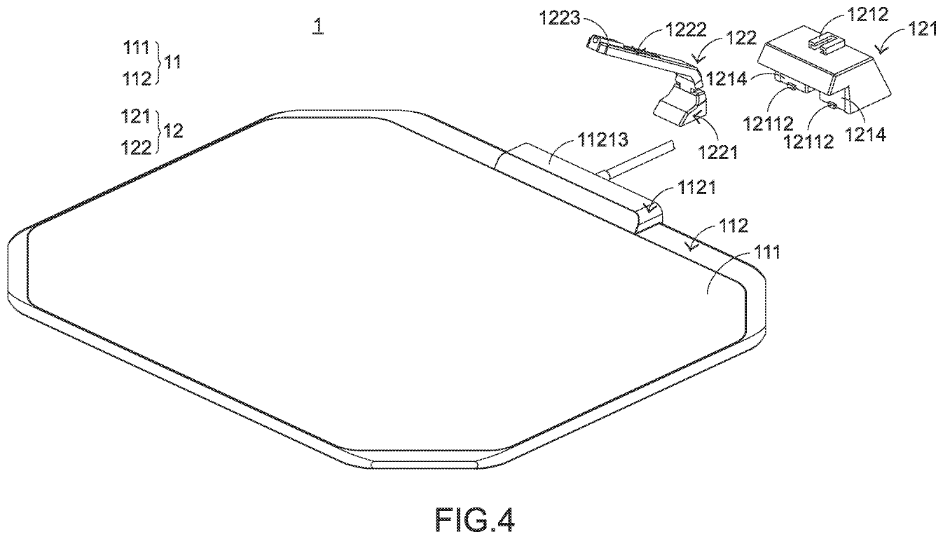

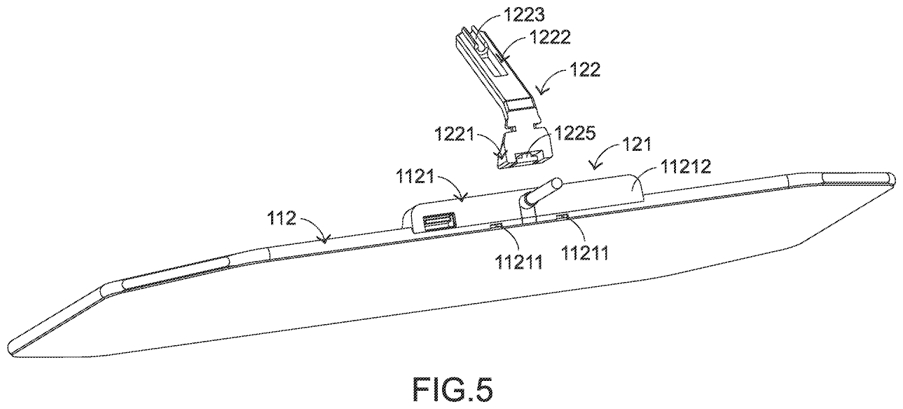

In accordance with a feature, the mouse peripheral device can be assembled or disassembled by the user. Please refer to FIGS. 4 and 5. FIG. 4 schematically illustrates the mouse peripheral device as shown in FIG. 1 in a disassembled status. FIG. 5 schematically illustrates the mouse pad module and the cable clamp element of the mouse peripheral device as shown in FIG. 4 and taken along another viewpoint. As shown in FIG. 4, the mouse peripheral device 1 is disassembled. The mouse peripheral device 1 comprises the mouse pad module 11, the base 121 and the cable clamp element 122. Moreover, the fixing frame 112 of the mouse pad module 11 comprises a frame coupling part 1121, and the base 121 of the mouse cable holder 12 further comprises a first base coupling part 1211. Through the first base coupling part 1211 and the frame coupling part 1121, the base 121 can be assembled with the fixing frame 112 or the base 121 can be disassembled from the fixing frame 112.

The base 121 of the mouse cable holder 12 further comprises a second base coupling part 1212. The first end part 1221 of the cable clamp element 122 of the mouse cable holder 12 comprises a clamp coupling part 1225. Through the second base coupling part 1212 and the clamp coupling part 1225, the cable clamp element 122 can be assembled with the base 121 or the cable clamp element 122 can be disassembled from the base 121.

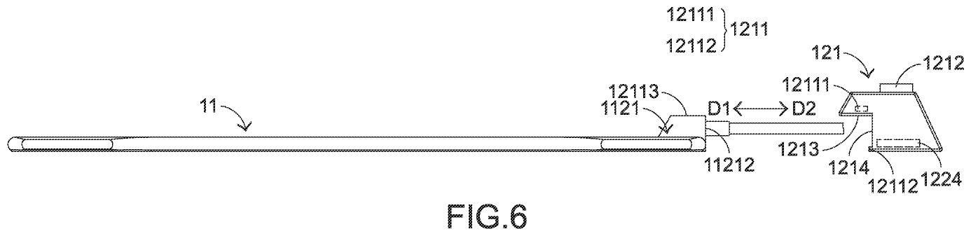

Please refer to FIGS. 4, 5 and 6. FIG. 6 is a schematic side view illustrating a process of assembling the mouse pad assembly with the base or disassembling the mouse pad assembly from the base. In an embodiment, the frame coupling part 1121 is installed on and protruded upwardly from an edge of the fixing frame 112. The frame coupling part 1121 comprises a first magnetic element and a frame positioning structure 11211. In an embodiment, the first magnetic element is the main structure of the frame coupling part 1121. Alternatively, the first magnetic element is an individual component that is disposed within the frame coupling part 1121. The frame positioning structure 11211 is located at a lateral surface 11212 of the frame coupling part 1121. Moreover, the base 121 of the mouse cable holder 12 further comprises a bottom side 1213 and a lateral side 1214. The lateral side 1214 is extended downwardly from the bottom side 1213. The first base coupling part 1211 comprises a second magnetic element 12111 and a base positioning structure 12112. The second magnetic element 12111 is disposed within the base 121. The base positioning structure 12112 is located at the lateral side 1214 of the base 121.

A process of assembling the mouse pad module 11 with the mouse cable holder 12 will be described as follows. Firstly, the fixing frame 112 and the base 121 are moved toward each other. As shown in FIG. 6, the base 121 is moved toward the fixing frame 112 in a direction D1. As the first magnetic element and the second magnetic element 12111 are magnetically attracted by each other, the bottom side 1213 of the base 121 is attached on a top surface 11213 of the frame coupling part 1121. Meanwhile, the lateral side 1214 of the base 121 is contacted with the lateral surface 11212 of the frame coupling part 1121. After the above process is completed, the base positioning structure 12112 is aligned with the frame positioning structure 11211. Consequently, the fixing frame 112 and the base 121 are positioned.

A process of disassembling the mouse pad module 11 from the mouse cable holder 12 will be described as follows. Firstly, an external force larger than the magnetic attractive force between the first magnetic element and the second magnetic element 12111 is provided to release the engagement between the base positioning structure 12112 and the frame positioning structure 11211. Consequently, the fixing frame 112 and the base 121 are separated from each other. As shown in FIG. 6, the base 121 is moved away from the mouse pad module 11 in a direction D2. Then, the base 121 is detached from the fixing frame 112.

Preferably but not exclusively, one of the base positioning structure 12112 and the frame positioning structure 11211 is a male engaging structure, and the other of the base positioning structure 12112 and the frame positioning structure 11211 is a female engaging structure. It is not that the example of the base positioning structure 12112 and the example of the frame positioning structure 11211 are not restricted. That is, the type of the base positioning structure and the type of the frame positioning structure may be varied according to the practical requirements.

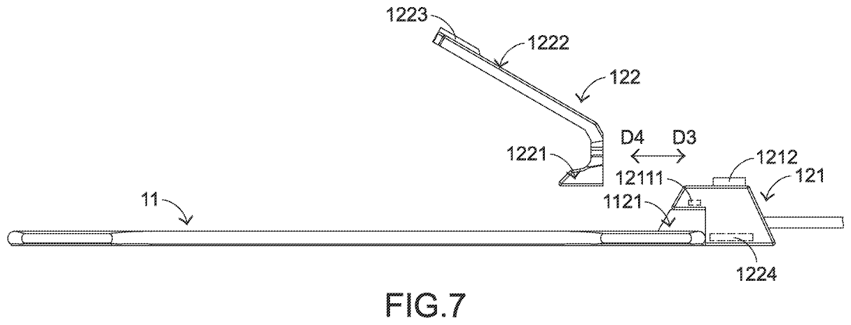

Please refer to FIGS. 4, 5 and 7. FIG. 7 is a schematic side view illustrating a process of assembling the base with the cable clamp element or disassembling the base from the cable clamp element.

In an embodiment, the second base coupling part 1212 of the base 121 is a sliding track structure, and the clamp coupling part 1225 of the cable clamp element 122 is a sliding block structure. For assembling the base 121 and the cable clamp element 122 of the mouse cable holder 12, the base 121 and the cable clamp element 122 are moved toward each other and the clamp coupling part 1225 (e.g., the sliding block structure) is slid into the second base coupling part 1212 (e.g., the sliding track structure) in a direction D3. Consequently, the cable clamp element 122 is assembled with the base 121. For disassembling the cable clamp element 122 from the base 121, the clamp coupling part 1225 (e.g., the sliding block structure) is disengaged from the second base coupling part 1212 (e.g., the sliding track structure) in a direction D4. Consequently, the cable clamp element 122 is detached from the base 121.

It is noted that the example of the second base coupling part 1212 and the example of the clamp coupling part 1225 are not restricted. That is, the example of the second base coupling part 1212 and the example of the clamp coupling part 1225 may be varied according to the practical requirements. In another embodiment, the second base coupling part 1212 of the base 121 is a sliding block structure, and the clamp coupling part 1225 of the cable clamp element 122 is a sliding track structure matching the sliding block structure.

From the above descriptions, the mouse peripheral device of the present invention can be assembled and disassembled by the user. Consequently, the volume of the product package is reduced, and the mouse peripheral device is easily carried by the user. In other words, the technology of the present invention is industrially valuable.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all modifications and similar structures.

What is claimed is:

1. A mouse peripheral device, comprising:
a mouse pad module comprising a mouse pad and a fixing frame, wherein a mouse device is movable on the mouse pad, and the mouse pad is accommodated within an accommodation space of the fixing frame, wherein the fixing frame comprises a frame coupling part; and
a mouse cable holder comprising:
a base comprising a first base coupling part, wherein through the first base coupling part and the frame coupling part, the base is permitted to be assembled with the fixing frame or disassembled from the fixing frame by a user; and
a cable clamp element comprising a first end part and a second end part, wherein the first end part and the second end part are respectively located at two opposite ends of the cable clamp element, the first end part is coupled with the base, and the second end part is inclined and extended upwardly, wherein the second end part comprises a clamping part, and a mouse cable is clamped by the clamping part.

2. The mouse peripheral device according to claim 1, wherein the frame coupling part comprises a first magnetic element, and the first base coupling part comprises a second magnetic element, wherein the first magnetic element and the second magnetic element are magnetically attractable by each other.

3. The mouse peripheral device according to claim 2, wherein the frame coupling part further comprises a frame positioning structure, and the first base coupling part further comprises a base positioning structure, wherein the frame positioning structure and the base positioning structure are engageable with each other.

4. The mouse peripheral device according to claim 3, wherein the frame coupling part is installed on and protruded upwardly from an edge of the fixing frame, and the base comprises a bottom side and a lateral side extended downwardly from the bottom side, wherein when the base and the fixing frame are combined together, the bottom side of the base is attached on a top surface of the frame coupling part through the first magnetic element and the second magnetic element, and the lateral side of the base is contacted with a lateral surface of the frame coupling part.

5. The mouse peripheral device according to claim 4, wherein the frame positioning structure is located at the lateral surface of the frame coupling part, and the base positioning structure is located at the lateral side of the base.

6. The mouse peripheral device according to claim 1, wherein the base further comprises a second base coupling part, and the first end part of the cable clamp element comprises a clamp coupling part, wherein through the second base coupling part and the clamp coupling part, the cable clamp element is permitted to be assembled with the base or disassembled from the base by the user.

7. The mouse peripheral device according to claim 6, wherein one of the second base coupling part and the clamp coupling part is a sliding block structure, and the other of the second base coupling part and the clamp coupling part is a sliding track structure corresponding to the sliding block structure.

8. The mouse peripheral device according to claim 1, wherein the cable clamp element is made of rubbery material.

9. The mouse peripheral device according to claim 1, wherein the base further comprises a weight block, and the weight block is disposed within the base.

10. A mouse cable holder, comprising:
a base disposed on a placement surface, and comprising a first base coupling part; and
a cable clamp element comprising a first end part and a second end part, wherein the first end part and the second end part are respectively located at two opposite ends of the cable clamp element, the first end part comprises a clamp coupling part, and the second end part is inclined and extended upwardly, wherein the second end part comprises a clamping part, and a mouse cable is clamped by the clamping part,
wherein through the clamp coupling part and the first base coupling part, the cable clamp element is permitted to be assembled with the base or disassembled from the base by a user.

11. The mouse cable holder according to claim 10, wherein one of the first base coupling part and the clamp coupling part is a sliding block structure, and the other of the first base coupling part and the clamp coupling part is a sliding track structure corresponding to the sliding block structure.

12. The mouse cable holder according to claim 10, wherein the cable clamp element is made of rubbery material.

13. The mouse cable holder according to claim 10, wherein the base further comprises a weight block, and the weight block is disposed within the base.

14. The mouse cable holder according to claim 10, wherein the mouse cable holder works with a mouse pad module, and the mouse pad module comprises a mouse pad and a fixing frame, wherein a mouse device is movable on the mouse pad, and the mouse pad is accommodated within an accommodation space of the fixing frame.

15. The mouse cable holder according to claim 14, wherein the base further comprises a second base coupling part, and the fixing frame comprises a frame coupling part, wherein through the second base coupling part and the frame coupling part, the base is permitted to be assembled with the fixing frame or disassembled from the fixing frame by the user.

16. The mouse cable holder according to claim 15, wherein the frame coupling part comprises a first magnetic element, and the second base coupling part comprises a second magnetic element, wherein the first magnetic element and the second magnetic element are magnetically attractable by each other.

17. The mouse cable holder according to claim 16, wherein the frame coupling part further comprises a frame positioning structure, and the second base coupling part further comprises a base positioning structure, wherein the frame positioning structure and the base positioning structure are engageable with each other.

18. The mouse cable holder according to claim 17, wherein the frame coupling part is installed on and protruded upwardly from an edge of the fixing frame, and the base comprises a bottom side and a lateral side extended downwardly from the bottom side, wherein when the base and the fixing frame are combined together, the bottom side of the base is attached on a top surface of the frame coupling part through the first magnetic element and the second magnetic element, and the lateral side of the base is contacted with a lateral surface of the frame coupling part

19. The mouse cable holder according to claim 18, wherein the frame positioning structure is located at the lateral surface of the frame coupling part, and the base positioning structure is located at the lateral side of the base.
